(19) United States
(12) Patent Application Publication
(10) Pub. No.: US 2016/0010545 A1
(43) Pub. Date: Jan. 14, 2016

(54) INTERNAL COMBUSTION ENGINE COMPRISING AN ELECTRIC DRIVE ON THE CRANKSHAFT

(71) Applicant: SIEMENS AKTIENGESELLSCHAFT, 80333 München (DE)

(72) Inventor: JOHANNES WOLLENBERG, Gräfelfing (DE)

(73) Assignee: SIEMENS AKTIENGESELLSCHAFT, 80333 München (DE)

(21) Appl. No.: 14/772,870

(22) PCT Filed: Mar. 5, 2013
(86) PCT No.: PCT/EP2013/054403

§ 371 Date: Sep. 4, 2015

(51) Int. Cl. F02B 73/00; F02F 7/00; H02K 7/18; F16C 7/02; H02P 9/00; F02F 3/00; F16C 3/06

(52) U.S. Cl. CPC F02B 73/00; F02F 3/00; F02F 7/0043; F16C 3/06; F16C 7/023; H02P 9/008; H02K 7/1807

(57) ABSTRACT

An internal combustion engine includes a crankshaft situated in a crankcase and having at least two crank journals, each mounted in a main bearing of the crankcase such that the crankshaft is rotatable about a rotational axis. The crankshaft has at least one crank pin running coaxially with the rotational axis and positioned eccentrically in relation to the axis. The pin is connected to the crank journals by crank webs and is connected to a number of pistons by a number of connecting rods. The respective pistons oscillate in a number of cylinders between a top dead centre and a bottom dead centre. The rotor of an electric machine is located on the crank webs. The stator of the electric machine is located on the crankcase. The stator of the electric machine interacts electromagnetically with the rotor and is connected to a converter unit to transmit electric energy bi-directionally.

The present invention relates to an internal combustion engine,
wherein the internal combustion engine has a crankshaft, which is arranged in a crankcase of the internal combustion engine,
wherein the crankshaft has at least two crank journals, each of which is mounted in a main bearing of the crankcase, so that the crankshaft can be rotated about a rotational axis,
wherein the crankshaft has at least one crank pin running coaxially with the rotational axis and arranged eccentrically in relation to the rotational axis, said pin being connected to the crank journals by means of crank webs,
wherein the crank pin is connected to a number of pistons by means of a number of connecting rods,
wherein the pistons oscillate in a number of cylinders, in each case between a top dead center and a bottom dead center.

Internal combustion engines of this type are generally known. In particular, all standard piston motors—including both two-stroke and four-stroke engines—work on this principle.

Energy conversion in the internal combustion engine cycle process is relatively inefficient. In particular, the time characteristic of the piston movement is essentially determined by the combustion parameters in conjunction with the load driven by the internal combustion engine and by the piston/connecting rod/crankshaft kinematics. In particular, the piston/connecting rod/crankshaft kinematics represent a limitation when optimizing the cycle process.

The object of the present invention is to further develop an internal combustion engine of the type cited in the introduction, such that it is compact in structure, reliable and highly efficient, and can be operated on a regulated basis in a simple manner.

The object is achieved by an internal combustion engine having the features of claim 1. Advantageous embodiments of the inventive internal combustion engine form the subject matter of the dependent claims 2 to 8.

According to the invention an internal combustion engine of the type cited in the introduction is configured in that
the rotor of an electric machine is arranged on the crank webs,
the stator of the electric machine is arranged on the crankcase,
the stator of the electric machine interacts electrically with the rotor of the electric machine and
the stator of the electromagnetic machine is connected to a converter unit for the bidirectional transmission of electromagnetic energy.

Thanks to this procedure the operation of the internal combustion engine can be optimized as required, subject to appropriate control of the converter unit. In particular, optimization is possible in respect of fuel consumption, emissions, output, efficiency, smooth running and other parameters.

In a preferred embodiment of the inventive internal combustion engine the stator is arranged on an external side of the crankcase. In particular in this case the crankcase preferably includes, at least in the region which is arranged between the stator and the rotor of the electric machine, of a nonmagnetizable or only slightly magnetizable material.

It is possible that the rotor extends—in relation to the rotational axis—over a full circle, in other words completely around the rotational axis. Alternatively the rotor extends only over one rotor sector.

Similarly it is possible that the stator extends—in relation to the rotational axis—over a full circle, in other words completely around the rotational axis. Alternatively the stator extends only over one stator sector.

In internal combustion engines counterbalance weights are often arranged on the crank webs. In a preferred embodiment of the inventive internal combustion engine the rotor of the electric machine is arranged on at least one of the counterbalance weights.

Preferably the crankshaft is associated with a position detector, by means of which a rotational position of the crankshaft is detected. In this case the rotational position of a controller can be delivered for the converter unit and the controller can control the converter unit as a function of the rotational position of the crankshaft.

Often the internal combustion engine has an accumulator. In this case it is possible for the converter unit to be supplied with electrical energy by means of the accumulator.

The properties, features and advantages described above of this invention and the way in which they are achieved will become clearer and more readily comprehensible in connection with the following description of the exemplary embodiments, which are explained in greater detail in conjunction with the drawings, in which:

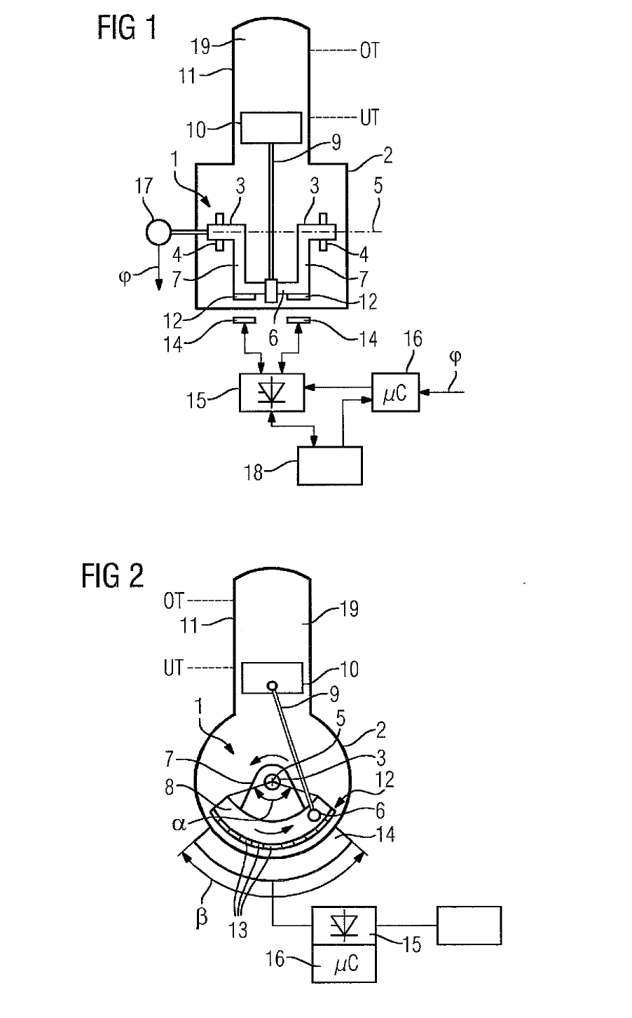

FIG. 1 schematically shows an internal combustion engine in longitudinal section and

FIG. 2 schematically shows the internal combustion engine from FIG. 1 in cross-section.

According to the figures an internal combustion engine has a crankshaft 1. The crankshaft 1 is arranged in a crankcase 2 of the internal combustion engine. The crankshaft 1 has at least two crank journals 3. The crank journals 3 are each mounted in a main bearing 4 of the crankcase 2. The crankshaft 1 can consequently be rotated about a rotational axis 5.

The crankshaft 1 further has a crank pin 6. The crank pin 6 runs coaxially with the rotational axis 5, but is arranged eccentrically in relation to the rotational axis 5. The crank pin 6 is connected to the crank journals 3 by means of crank webs 7. Counterbalance weights 8 can be arranged radially outward on the crank webs 7.

The crank pin 6 is connected to a piston 10 by means of a connecting rod 9. The piston 10 oscillates in a cylinder 11 between a top dead center OT and a bottom dead center UT.

The rotor 12 of an electric machine is arranged on the crank webs 7. The rotor 12 is preferably arranged as radially outward as possible. In particular the rotor 12 can be arranged on at least one of the counterbalance weights 8.

The rotor 12 can for example, in accordance with the illustration in FIG. 1, comprise permanent magnets 13. In this case the electric machine is designed as a permanently excited synchronous machine. Alternatively the rotor 12 could have a winding. In this case the electric machine would be designed as an electrically excited synchronous machine. Alternatively again the electric machine could for example be designed as an asynchronous machine. Other embodiments are also possible.

The rotor 12 in the main does not extend over a full circle, but only over one sector α, referred to below as rotor sector α. The rotor sector α generally lies between 90° and 180°, for example at approx. 100° to 120°. However, extension over a full circle is possible if the rotor 12 is arranged outside the range of movement of the piston 10.

The stator 14 of the electric machine is arranged on the crankcase 2. In the case of an electric radial flow machine the stator 14 is preferably arranged as radially inward as possible. In an electric axial flow machine the stator 14 is arranged at the same radial distance from the rotational axis 5 as the rotor 12. The stator 14 interacts electromagnetically with the rotor 12.

The stator 14 of the electric machine is connected to a converter unit 15 for the bidirectional transmission of electrical energy. The electric machine works—depending on the control status of the converter unit 15—like a generator or motor.

According to the figures the stator 14 is preferably arranged on an external side of the crankcase 2. The crankcase 2 is thus located between the rotor 12 and the stator 14, i.e. in the so-called air gap. Preferably the crankcase 2 therefore includes, at least in the region which is arranged between the stator 14 and the rotor 12 of the electric machine, of a nonmagnetizable material. One example of a suitable material is aluminum. Alternatively heat-resisting plastics, for example polyimides, can also be considered. Alternatively the crankcase 2 in the said region can be made of an only slightly magnetizable material, for example a high-alloy steel.

Similarly to the rotor 12, the stator 14 also in the main does not extend over a full circle, but only over one sector β, referred to below as stator sector β. The stator sector β generally lies between 90° and 180°, for example at approx. 100° to 120°. According to the figures the size of the stator sector β is the same as that of the rotor sector α. However, this is not mandatory. Similarly to the rotor 12, an extension over a full circle is possible if the stator 14 is arranged outside the cylinder 11.

A controller 16 is provided for the proper control of the converter unit 15. To be able to control the converter unit 15 properly, it is however often additionally necessary (among other things) for a rotational position φ of the crankshaft 1 to be known to the controller 16. Preferably the crankshaft 1 is hence associated with a position detector 17, by means of which the rotational position φ is detected. The detected rotational position φ is in this case passed to the controller 16. The controller 16 is hence able to control the converter unit 15 as a function of the rotational position φ of the crankshaft 1. The rotational position φ can—for example in the case of a single-cylinder four-stroke engine—be related to modulo 720° (=4π). Often a modulo 360° (=2π) determination is sufficient.

In many case—for example in use as an emergency power unit or in use as the main drive of a vehicle—the internal combustion engine has an accumulator 18. In this case it is for example possible for the converter unit 15 (if appropriate including the controller 16 and any other components of the electric machine) to be supplied with electrical energy by means of the accumulator 18.

By integrating the electric machine into the internal combustion engine a torque can be applied selectively to the crankshaft 1 on the basis of time and/or position. By means of the controller 16 time-variable torques can be predefined in connection with the performance of the electric machine and the converter unit 15. This therefore makes it possible to intervene actively in respect of the piston movement and consequently in respect of the pressure gradient and the combustion behavior in a working space 19 of the internal combustion engine.

The electric machine and the converter unit 15 can be dimensioned as required. It is possible for it to work merely in a support capacity—similarly to the electric starter or alternator in a car engine. Alternatively it is possible to dimension the electric machine and the converter unit 15 such that virtually all the mechanical energy provided by the internal combustion engine is converted into electrical energy.

The inventive internal combustion engine was explained above in conjunction with a single-cylinder motor. However, it can readily also be applied to internal combustion engines having several cylinders 11. The cylinders 11 can in this case be arranged at will in line, in V formation, star formation, etc. In this case a piston 10 is present for each cylinder 11. Furthermore, for each piston 10 at least one connecting rod 9 is present—generally one for each piston. In many cases each connecting rod 9 is connected to a separate crank pin 6, for example in in-line motors. In other cases, for example in star motors, V motors and boxer motors, several connecting rods 9 are present for each crank pin 6.

Although the invention has been illustrated and described in greater detail using the preferred exemplary embodiment, the invention is not restricted to the disclosed examples and other variations can be derived therefrom by the person skilled in the art, without departing from the scope of protection of the invention.

What is claimed is:

1-7. (canceled)

8. An internal combustion engine, comprising:
a crankcase;
a crankshaft arranged in the crankcase and having at least two crank journals which are each mounted in a main bearing of the crankcase, so that the crankshaft is rotatable about a rotational axis, said crankshaft having at least one crank pin extending in coaxial relationship to the rotational axis and arranged eccentrically in relation to the rotational axis; said crank pin being connected to the crank journals by crank webs, said crank pin being connected via a connecting rod to a piston which oscillates in a cylinder between a top dead center and a bottom dead center;
a converter unit;
an electric machine having a rotor which is arranged on the crank webs, and a stator arranged on the crankcase and interacting electromagnetically with the rotor, said stator being connected to the converter unit for bidirectional transmission of electrical energy;
a position detector operably connected to the crankshaft to detect a rotational position of the crankshaft; and
a controller receiving the rotational position from the position detector and configured to control the converter unit such that as a function of the rotational position of the crankshaft a time-variable torque is applied to the crankshaft to thereby actively intervene in a movement of the piston and consequently in a pressure gradient and a combustion behavior in a working space of the internal combustion engine.

9. The internal combustion engine of claim 8, wherein the stator is arranged on an external side of the crankcase.

10. The internal combustion engine of claim 8, wherein the crankcase is made, at least in a region between the stator and the rotor, of nonmagnetizable or only slightly magnetizable material.

11. The internal combustion engine of claim 8, wherein the rotor is sized to extend over a full circle or only over one rotor sector.

12. The internal combustion engine of claim 8, wherein the stator is sized to extend over a full circle or only over one stator sector.

13. The internal combustion engine of claim 8, further comprising counterbalance weights arranged on the crank webs, said rotor being arranged on at least one of the counterbalance weights.

14. The internal combustion engine of claim 8, further comprising an accumulator, said converter unit being supplied with electrical energy from the accumulator.
